(19) United States
(12) Patent Application Publication
(10) Pub. No.: US 2011/0296480 A1
(43) Pub. Date: Dec. 1, 2011

(54) SYSTEM, TERMINAL, SERVER AND METHOD FOR PROVIDING RICH APPLICATION BASED MULTI-SCREEN IPTV SERVICE

(75) Inventors: Sung Han Kim, Daejeon (KR); Seung Yun Lee, Daejeon (KR)

(73) Assignee: ELECTRONICS AND TELECOMMUNICATIONS RESEARCH INSTITUTE, Daejeon (KR)

(21) Appl. No.: 13/114,383

(22) Filed: May 24, 2011

(30) Foreign Application Priority Data
May 25, 2010 (KR) 10-2010-0048813
May 23, 2011 (KR) 10-2011-0048555

(51) Int. Cl. H04N 7/173

(52) U.S. Cl. 725/109

(57) ABSTRACT

A system, terminal, server, and method for providing a rich application-based multi-screen IPTV service are disclosed. The system for providing a rich application-based multi-screen IPTV service includes: an IPTV system providing an IPTV service to two or more terminals; and a multi-screen management server supporting a multi-screen service of the IPTV service provided by the IPTV system by interworking with a multi-screen management module provided in the terminals.

### CROSS-REFERENCE TO RELATED APPLICATIONS

This application claims the priority of Korean Patent Application No. 10-2010-0048813 filed on May 25, 2010 and No. 10-2011-0048555 filed on May 23, 2011, in the Korean Intellectual Property Office, the disclosure of which is incorporated herein by reference.

### BACKGROUND OF THE INVENTION

1. Field of the Invention

The present invention relates to a system, terminal, server, and method for providing a rich application-based multi-screen Internet Protocol television (IPTV) service, and more particularly, to a multi-screen terminal middleware management module and a multi-screen management server at a server side, additionally required to provide a multi-screen service based on a rich application in an existing IPTV service environment, and a method for providing a multi-screen IPTV service by associating a terminal and a server.

2. Description of the Related Art

Conventionally, there has been a system having a basic function of providing an IPTV service between a single terminal and a server. However, additional terminal and server structures, required to provide a multi-screen service to various terminals based on a rich application have not been proposed yet.

### SUMMARY OF THE INVENTION

An aspect of the present invention provides a terminal having a multi-screen management module added to middleware and a multi-screen management server at a server side to provide a multi-screen service based on a rich application in an existing IPTV service environment, and a method for providing a multi-screen IPTV service by associating a terminal and a server.

According to an aspect of the present invention, there is provided a system for providing a rich application-based multi-screen IPTV service, including: an IPTV system providing an IPTV service to two or more terminals; and a multi-screen management server supporting a multi-screen service of the IPTV service provided by the IPTV system by interworking with a multi-screen management module provided in each of the terminals.

According to another aspect of the present invention, there is provided a terminal which includes a rich Web application and middleware and receives a rich application-based multi-screen IPTV service, wherein the middleware includes a multi-screen management module supporting a multi-screen service by performing a controlling content function and service for stopping the IPTV service which has been receiving and a service connection to a different terminal.

According to another aspect of the present invention, there is provided a multi-screen management server supporting a multi-screen service of an IPTV service by interworking with a multi-screen management module provided in a terminal receiving the IPTV service, including: a terminal information management module managing terminal environment information; a media conversion management module converting a media content format according to terminal environment information of a terminal; and a content control module managing information regarding a current state and a processed state of content when a media content service is stopped or re-requested.

According to another aspect of the present invention, there is provided a method for providing a rich application-based multi-screen IPTV service through a multi-screen management server provided at a server side providing an IPTV service, including: receiving a service stop signal from a terminal which has been receiving a rich application-based multi-screen IPTV service; receiving a request for an ongoing service from a different terminal to which the IPTV service is to be moved; processing a media conversion according to terminal environment information regarding the different terminal; transmitting content control information regarding the terminal and the different terminal to an IPTV system; and transmitting the converted media to the different terminal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view showing a basic configuration of a system for providing a rich application-based multi-screen IPTV service according to an embodiment of the present invention;

FIG. 2 is a view showing a detailed configuration of the system for providing a rich application-based multi-screen IPTV service according to an embodiment of the present invention; and

FIG. 3 is a flow chart illustrating a process of a method for providing a rich application-based multi-screen IPTV service according to an embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

It will be understood that when an element is referred to as being “connected with” another element, it can be directly connected with the other element or intervening elements may also be present. In contrast, when an element is referred to as being “directly connected with” another element, there are no intervening elements present.

In order to provide a multi-screen service based on a rich application in an existing IPTV service environment, additional terminal middleware and a service structure are required.

Here, a rich application, which refers to a general desk top-based application operating in an IPTV service environment, has characteristics such as a frequent user interaction, an excellent user interface, or the like. Also, compared with existing applications, the rich application has expandability such as being able to directly access terminal resources and being associated with a mash-up service based on an open API to provide a new service, and provides a convergence service according to various terminal environments in association even with a service, such as a social network, or the like. For example, the rich application may be a Widget application.

Meanwhile, a multi-screen service refers to a service supported in a situation optimized according to a changed terminal environment without losing continuity of the service among various terminals. In order to support such a multi-screen service, a terminal and a service side system require an additional function in an existing IPTV service structure.

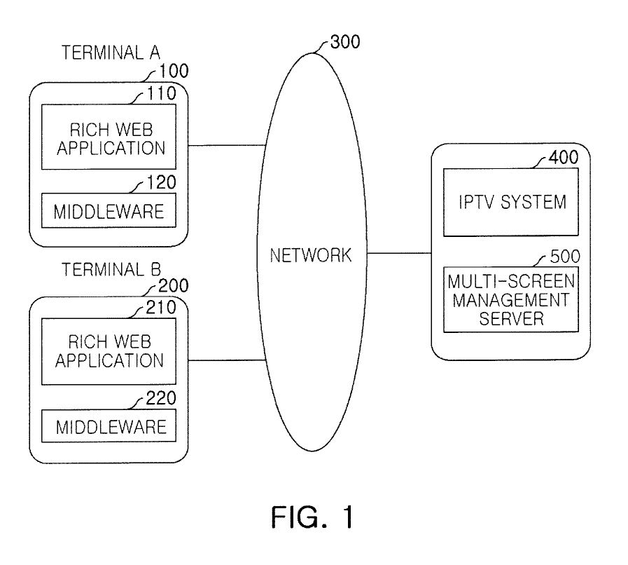

FIG. 1 is a view showing a basic configuration of a system for providing a rich application-based multi-screen IPTV service according to an embodiment of the present invention.

With reference to FIG. 1, a system for providing a rich application-based multi-screen IPTV service according to an embodiment of the present invention is configured to include two or more terminals 100 and 200, a network 300, an IPTV system 400, and a multi-screen management server 500.

A terminal A 100 and a terminal B 200, which are connected to the network 300 to receive an IPTV service, may be implemented in various forms such as a set-top scheme, a PC type style, a mobile environment, or the like.

The terminal A 100 and the terminal B 200 are configured to include rich Web applications 110 and 210 and middlewares 120 and 220, respectively. Here, as the middlewares 120 and 220, a basic terminal middleware function is utilized, and besides the basic function, a module for supporting the multi-screen service is required, and this module can be supported by a plug-in scheme.

The network 300 basically provides an IP-based network protocol or may be implemented by a cable, a mobile network, or the like.

The IPTV system 400, which refers to an existing IPTV service system, may be configured to include a content generation function, a service transfer function, a Web server, a media server, and the like.

The multi-screen management server 500 is required for a service side to support the multi-screen service. The multi-screen management server operates in association with a multi-screen management function additionally provided in the middleware of a terminal. The multi-screen management server includes functions such as terminal information management, media conversion management, content controlling, or the like.

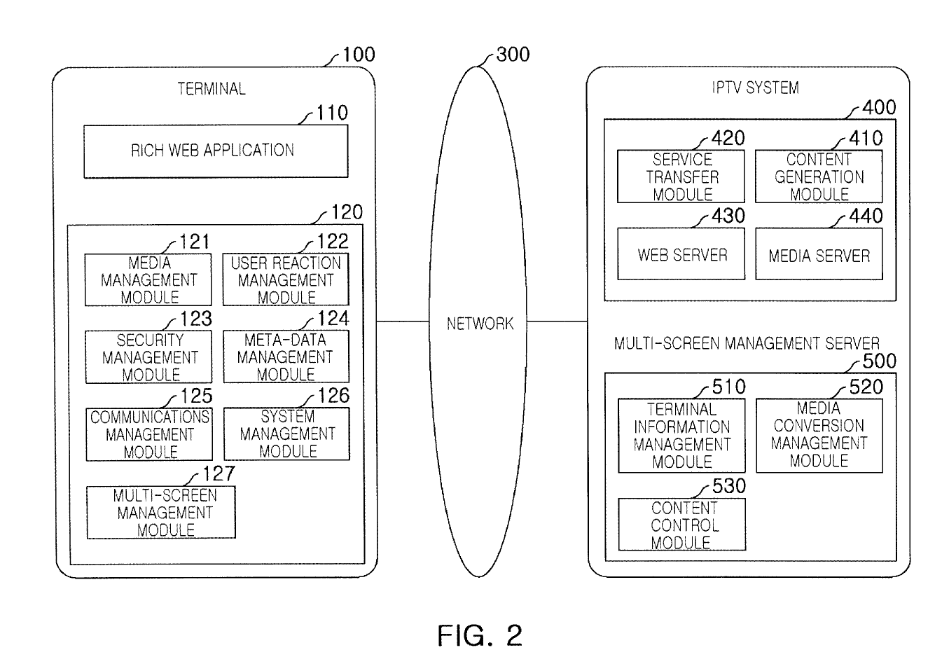

FIG. 2 is a view showing a detailed configuration of the system for providing a rich application-based multi-screen IPTV service according to an embodiment of the present invention.

A rich Web application 110 of the terminal 100, for example, has a character of a rich application supporting dynamic interaction processing between a user and the terminal, while accessing a terminal resource such as a sensor, or various peripheral devices. In order to perform the rich Web application 110, terminal middleware is required, and in this case, a multi-screen management module for supporting the multi-screen service along with general functions of the terminal middleware is utilized.

The middleware 120 of the terminal 100 further includes a multi-screen management module 127 in addition to the general middleware functions of the terminal. Here, the general middleware functions of the terminal include a media management module 121, a user reaction management module 122, a security management module 123, a meta-data management module 124, a communications management module 125, and a system management module 126.

The media management module 121 provides a function for a media streaming service, and has a management function with respect to a storage device of the terminal. Through the media management module 121, an IPTV media service can be provided.

The user reaction management module 122 supports interaction with a user through the rich Web application 110 and provides a program event processing function.

The security management module 123 supports user authentication, granting authority with respect to media, network security, or the like.

The meta-data management module 12, which is utilized when the rich Web application 110 operates together with a meta-data system (not shown), provides a function of accessing the meta-data system and a management function.

The communications management module 125 supports a communication function of the terminal 100.

The system management module 126 provides a function of initializing the terminal 100 and a resource management function.

The multi-screen management module 127 supports a multi-screen service in the terminal 100. In order to support the multi-screen service, the multi-screen management module 127 cooperates with a multi-screen management server 500 at a server side in order to support the multi-screen service. While the terminal 100 is receiving the IPTV service, the multi-screen management module 127 temporarily stops the IPTV service or performs a function of controlling and managing content and a service for a service connection to a different terminal, or the like. Here, the multi-screen management module 127 is required to have a function of communicating with the server side and to have an interface connection with the rich Web application 110.

The network 300 basically provides an IP-based network protocol. The network 300 may be implemented as a cable network, a mobile network, or the like. The network 300 is required to have a function of network mobility in various access network situations for the IPTV service.

The IPTV system 400, an existing general IPTV system, may be configured to include a content generation module 410, a service transfer module 420, a Web server 430, and a media server 440.

The content generation module 410 performs a function of producing content for the IPTV service, and is able to produce various contents such as audio and video contents, or the like.

The service transmission module 420 performs a function of transmitting content and a service. The service transmission module 420 may be, for example, an existing IPTV head-end system function.

The Web server 430 performs a function of processing a Web page, text, or the like.

The media server 430 performs a function of supporting a media streaming service for the terminal 100.

The multi-screen management server 500 supports the multi-screen service for the existing IPTV system. The multi-screen management server 500 may be configured to include a terminal information management module 510, a media conversion management module 520, and a content control module 530.

The terminal information management module 510 performs a function of managing terminal environment information. Here, the terminal environment information may include a type of a terminal, the version of software mounted in the terminal, a user's profile information, and the like.

The media conversion management module 520, aiming at optimizing a media format such that it can fit various types of terminals, performs a function of converting a media content format according to information regarding the environment of a moving terminal.

The content control module 530 performs a function of managing a current state of content and various types of processing information when a media content service is stopped or re-requested.

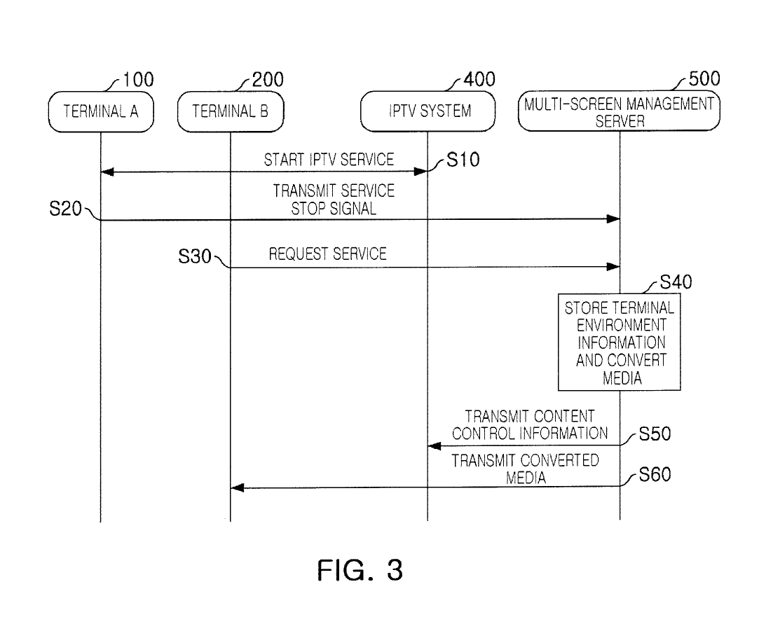

FIG. 3 is a flow chart illustrating a process of a method for providing a rich application-based multi-screen IPTV service according to an embodiment of the present invention.

In order to support a multi-screen service, the multi-screen management module must be mounted in the terminal, and a service can be supported by utilizing a heterogeneous terminal.

A rich application-based IPTV service is started and ongoing between the terminal A 100 and the IPTV system 400 (S10).

The terminal A 100 stops an ongoing service, and transmits a service stop signal to the multi-screen management server 500 (S20).

Also, the terminal B 200 requests the ongoing service from the multi-screen management server 500 (S30).

In this case, the multi-screen management server 500 receives signals from the terminal A 100 and the terminal B 200, respectively, stores terminal environment information, and converts media according to the terminal environment information of the terminal B 200 (S40).

Thereafter, the multi-screen management server 500 transmits content control information with respect to the terminal A 100 and the terminal B 200 to the IPTV system 400 (S50), and transmits the media which has been converted according to the terminal environment information of the terminal B 200 to the terminal B 200 (S60).

As set forth above, according to embodiments of the invention, a user can be provided with an IPTV service through several terminals. In particular, when the user wants to stop receiving an IPTV service through one terminal and continuously receive the IPTV service by using a different terminal, the IPTV service can be continuously provided according to a changed terminal environment. Namely, mobility of the IPTV service between terminals and continuity of content can be guaranteed.

Also, a new IPTV service utilizing an open API, as well as a rich application-based service utilizing resource of a terminal, can be provided.

While the present invention has been shown and described in connection with the embodiments, it will be apparent to those skilled in the art that modifications and variations can be made without departing from the spirit and scope of the invention as defined by the appended claims.

What is claimed is:

1. A system for providing a rich application-based multi-screen IPTV service, the system comprising:
an IPTV system providing an IPTV service to two or more terminals; and
a multi-screen management server supporting a multi-screen service of the IPTV service provided by the IPTV system by interworking with a multi-screen management module provided in the terminals.

2. The system of claim 1, wherein the IPTV system comprises:
a content generation module producing content for the IPTV service;
a service transfer module transmitting content and a service;
a Web server performing a function of processing a Web page and text; and
a media server supporting a media streaming service with respect to the terminals.

3. The system of claim 1, wherein the multi-screen management server comprises:
a terminal information management module managing terminal environment information;
a media conversion management module converting a media content format according to terminal environment information of a terminal which moves; and
a content control module managing information regarding a current state and a processed state of content when a media content service is stopped or re-requested.

4. A terminal which includes a rich Web application and middleware and receives a rich application-based multi-screen IPTV service,
wherein the middleware includes a multi-screen management module supporting a multi-screen service by performing a controlling content function and service for stopping the IPTV service which has been receiving and a service connection to a different terminal.

5. The terminal of claim 4, wherein the middleware comprises:
a media management module having a function for a media streaming service and a management function with respect to a storage device of the terminal;
a user reaction management module supporting interaction with a user through the rich Web application, and providing a program event processing function;
a security management module supporting a security mechanism;
a meta-data management module providing a function of accessing and managing a meta-data system;
a communications management module supporting a communication function; and
a system management module providing a function of initializing the terminal and managing resource.

6. A multi-screen management server supporting a multi-screen service of an IPTV service by interworking with a multi-screen management module provided in a terminal receiving the IPTV service, the server comprising:
a terminal information management module managing terminal environment information;
a media conversion management module converting a media content format according to terminal environment information of a terminal; and
a content control module managing information regarding a current state and a processed state of content when a media content service is stopped or re-requested.

7. A method for providing a rich application-based multi-screen IPTV service through a multi-screen management server provided at a server side providing an IPTV service, the method comprising:
receiving a service stop signal from a terminal which has been receiving a rich application-based multi-screen IPTV service;
receiving a request for an ongoing service from a different terminal to which the IPTV service is to be moved;
processing a media conversion according to terminal environment information regarding the different terminal;
transmitting content control information regarding the terminal and the different terminal to an IPTV system; and
transmitting the converted media to the different terminal.
